(19) United States
(12) Patent Application Publication
(10) Pub. No.: US 2022/0281140 A1
(43) Pub. Date: Sep. 8, 2022

(54) THERMAL DECOMPOSITION TREATMENT APPARATUS AND THERMAL DECOMPOSITION TREATMENT METHOD

(71) Applicant: HONDA MOTOR CO., LTD., Tokyo (JP)

(72) Inventors: Kazuhiro Miura, Wako-shi (JP); Tadahiro Shiba, Wako-shi (JP); Syouji Inose, Wako-shi (JP); Masaki Namaizawa, Wako-shi (JP)

(73) Assignee: HONDA MOTOR CO., LTD., Tokyo (JP)

(21) Appl. No.: 17/679,457

(22) Filed: Feb. 24, 2022

(30) Foreign Application Priority Data
Mar. 4, 2021 (JP) 2021-034619

(51) Int. Cl. B29B 17/04; B29B 7/42

(52) U.S. Cl. CPC B29B 17/04; B29B 7/42; B29B 2017/0496; B29K 2105/26

(57) ABSTRACT

There is provided with a thermal decomposition treatment apparatus capable of thermally decomposing a resin under an appropriate thermal decomposition condition. The thermal decomposition treatment apparatus comprises: a thermal decomposition treatment unit configured to thermally decompose a recycled material containing a resin; a detection unit configured to detect an impurity in the recycled material to be introduced into the thermal decomposition treatment unit; and a determination unit configured to determine a condition related to an introduction amount of a virgin material of the resin to be introduced, together with the recycled material, into the thermal decomposition treatment unit, based on a detection result of the detection unit.

### CROSS-REFERENCE TO RELATED APPLICATION(S)

This application claims priority to and the benefit of Japanese Patent Application No. 2021-034619 filed on Mar. 4, 2021, the entire disclosure of which is incorporated herein by reference.

### BACKGROUND OF THE INVENTION

### Field of the Invention

The present invention relates to a thermal decomposition treatment apparatus and a thermal decomposition treatment method.

### Description of the Related Art

In various technical fields, such as automobiles, vessels, railway vehicles, office equipment, electronic equipment, and buildings, products or parts are manufactured with resins. On the other hand, from the viewpoint of resource reuse, unnecessary products are collected and reused (recycled). Collected resins are thermally decomposed, and are recovered as monomers, oil, or the like. Japanese Patent Laid-Open No. 10-510280 discloses a technique for melting and compressing a polycaprolactam-containing waste, carrying out a hydrolysis treatment, and recovering caprolactam.

### SUMMARY OF THE INVENTION

According to one embodiment of the present invention, a thermal decomposition treatment apparatus comprises: a thermal decomposition treatment unit configured to thermally decompose a recycled material containing a resin; a detection unit configured to detect an impurity in the recycled material to be introduced into the thermal decomposition treatment unit; and a determination unit configured to determine a condition related to an introduction amount of a virgin material of the resin to be introduced, together with the recycled material, into the thermal decomposition treatment unit, based on a detection result of the detection unit.

According to another embodiment of the present invention, a thermal decomposition treatment apparatus comprises: a thermal decomposition treatment unit configured to thermally decompose a recycled material containing a resin; a detection unit configured to detect an impurity in a decomposition product that has been decomposed by the thermal decomposition treatment unit; and a determination unit configured to determine a condition related to an introduction amount of a virgin material of the resin to be introduced, together with the recycled material, into the thermal decomposition treatment unit, based on a detection result of the detection unit.

According to still another embodiment of the present invention, a thermal decomposition treatment method comprises: thermally decomposing a recycled material containing a resin; detecting an impurity in the recycled material to be introduced in the thermally decomposing; and determining a condition related to an introduction amount of a virgin material of the resin to be thermally decomposed, together with the recycled material, in the thermally decomposing, based on a detection result of the detecting.

According to yet another embodiment of the present invention, a thermal decomposition treatment method comprising: thermally decomposing a recycled material containing a resin; detecting an impurity in a decomposition product that has been decomposed by the thermally decomposing; and determining a condition related to an introduction amount of a virgin material of the resin to be thermally decomposed, together with the recycled material, in the thermally decomposing, based on a detection result of the detecting.

### BRIEF DESCRIPTION OF THE DRAWINGS

FIG. 1 is a schematic diagram of a thermal decomposition treatment apparatus according to one embodiment;

FIG. 2 is a schematic diagram of the thermal decomposition treatment apparatus according to another embodiment;

FIG. 3 is a schematic diagram of a resin introduction part of the thermal decomposition treatment apparatus according to still another embodiment;

FIG. 4 is a block diagram of the thermal decomposition treatment apparatus;

FIG. 5 is a flowchart illustrating introduction of a virgin material according to one embodiment;

FIG. 6 is a flowchart illustrating the introduction of the virgin material according to one embodiment;

FIG. 7 is a flowchart for describing the introduction of the virgin material according to another embodiment; and

FIG. 8 is a flowchart for describing the introduction of the virgin material according to still another embodiment.

### DESCRIPTION OF THE EMBODIMENTS

In a thermal decomposition treatment for resins, the thermal decomposition treatment may be carried out by adding a resin (virgin material) that is the same type with the collected resin (recycled material) and that contains less amount of impurities. However, the resin may not be thermally decomposed in an appropriate manner, because the impurities in the recycled material are not constant, and the like.

In one embodiment of the present invention, a thermal decomposition treatment apparatus capable of thermally decomposing a resin under an appropriate thermal decomposition condition is provided.

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

<Thermal Decomposition Treatment Apparatus According to One Embodiment>

A thermal decomposition treatment apparatus according to one embodiment includes: a thermal decomposition treatment unit configured to thermally decompose a recycled material containing a resin; a detection unit configured to detect an impurity in the recycled material to be introduced into the thermal decomposition treatment unit; and a determination unit configured to determine a condition related to an introduction amount of a virgin material of the resin to be introduced, together with the recycled material, into the thermal decomposition treatment unit, based on a detection result of the detection unit. This configuration enables a thermal decomposition treatment on the resin under an appropriate thermal decomposition condition. In addition, the recycled resin material contains a resin that has been collected from various unnecessary products or parts, and can contain impurities of an organic substance such as a resin different from the main component resin, and an inorganic substance such as metal or glass. In addition, the virgin material of the resin is a resin of the same type with the recycled material, and is a resin substantially containing no impurities or a resin with a low content ratio of impurities.

(Thermal Decomposition Treatment Apparatus)

A thermal decomposition treatment apparatus that carries out a thermal decomposition on the resin thermally decomposes, by a thermal decomposition treatment unit, a recycled material containing a resin, and recovers a decomposition product such as a monomer, and includes a continuous type of thermal decomposition treatment apparatus and a batch type of thermal decomposition treatment apparatus. Hereinafter, the continuous type of thermal decomposition treatment apparatus will be described as an example of the thermal decomposition treatment apparatus.

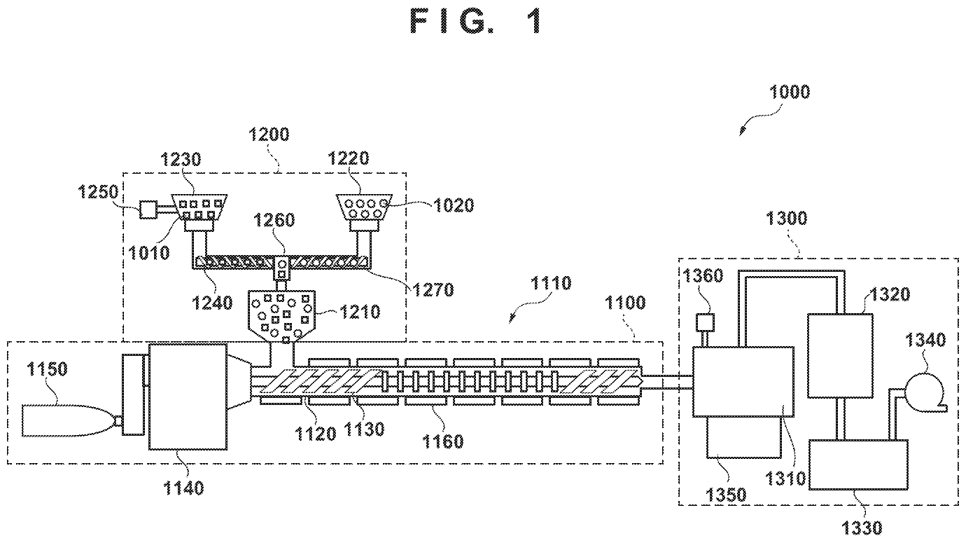

FIG. 1 is a schematic diagram of a thermal decomposition treatment apparatus according to one embodiment. A thermal decomposition treatment apparatus 1000 includes a thermal treatment part 1100, a resin introduction part 1200, and a decomposition product recovery part 1300. Hereinafter, the configuration of each part will be described.

(Thermal Treatment Part)

The thermal treatment part 1100 includes a thermal decomposition treatment unit 1110, and the thermal decomposition treatment unit 1110 carries out the thermal treatment on a recycled material 1010 containing a resin and a virgin material 1020. Hereinafter, a mixture of the recycled material 1010 containing the resin and the virgin material 1020 will be referred to as a resin mixture material, in some cases. The thermal decomposition treatment unit 1110 according to one embodiment is an extruder, and may be a single screw extruder or a twin screw extruder. The thermal decomposition treatment unit 1110 includes a barrel 1120, a screw 1130, a speed reducer 1140, a motor 1150, and a heater 1160.

The barrel 1120 includes a heater 1160 on an outer peripheral surface, and the barrel 1120 is configured to heat the resin mixture material in a sealed state. In addition, an upstream side of the barrel 1120 is a molten resin zone, a downstream side thereof is a thermal decomposition zone. The thermal decomposition zone is configured to thermally decompose and gasify the resin that has been melted in the molten resin zone.

The screw 1130 is provided inside the barrel 1120, and the screw 1130 is connected with the motor 1150 through the speed reducer 1140. With this configuration, the resin mixture material that has been melted in the molten resin zone is extruded into the thermal decomposition zone, and is thermally decomposed. In addition, the screw 1130 is capable of thermally decomposing the resin under optimum conditions in an apparatus that continuously carries out the thermal decomposition treatment.

(Resin Introduction Part)

The resin introduction part 1200 includes a resin introduction unit 1210, and the resin introduction unit 1210 introduces the resin mixture material into the upstream side of the barrel 1120. The resin introduction unit 1210 is not particularly limited, as long as it is capable of introducing the resin mixture material. A hopper is given as an example. An outlet of the resin mixture material is provided in a lower part (on a downstream side) of the resin introduction unit 1210, and an introduction amount or an introduction speed of the resin mixture material into the barrel 1120 is adjustable. In addition, the introduction amount or the introduction speed of the resin mixture material may be automatically adjusted by the thermal decomposition treatment apparatus 1000, or may be adjusted by an operator.

An inlet for the resin mixture material is provided in an upper part (on an upstream side) of the resin introduction unit 1210. In one embodiment, the thermal decomposition treatment apparatus 1000 includes a virgin material introduction unit 1220 for introducing the virgin material 1020, and a recycled material introduction unit 1230 for introducing the recycled material 1010.

The recycled material introduction unit 1230 includes a resin transfer device 1240, and the resin transfer device 1240 is connected with an outlet in a lower part (on a downstream side) of the recycled material introduction unit 1230. In FIG. 1, the recycled material introduction unit 1230 is connected with a mixing unit 1260, but may be connected with the resin introduction unit 1210. The resin transfer device 1240 is capable of adjusting a condition related to an introduction amount of the recycled material 1010 into the thermal decomposition treatment unit 1110, for example, a condition that can change an introduction amount, an introduction speed, and the like. The resin transfer device 1240 is not particularly limited, but a conveyor, a screw feeder, or the like is given as an example. In addition, the introduction amount or the introduction speed of the recycled material 1010 may be automatically adjusted by the thermal decomposition treatment apparatus 1000, or may be adjusted by the operator.

In one embodiment, the recycled material introduction unit 1230 is provided with a detection unit 1250 for detecting impurities in the recycled material 1010. Hereinafter, the detection unit 1250 for detecting impurities in the recycled material 1010 will be referred to as an impurity detection unit, in some cases. In FIG. 1, the detection unit 1250 is provided at the recycled material introduction unit 1230, but may be provided at the resin introduction unit 1210, or may be provided at a configuration, for example, the mixing unit 1260, between the recycled material introduction unit 1230 and the resin introduction unit 1210.

The detection unit 1250 is configured to detect the content ratio of the impurities or the amount of the impurities, and may be configured to additionally detect physical properties of the impurities. Note that in a case where the detection unit 1250 is provided at a position before the recycled material 1010 is mixed with the virgin material 1020 (for example, the recycled material introduction unit 1230), the detection unit 1250 detects the content ratio of the impurities in the recycled material 1010, as the impurities in the recycled material 1010. On the other hand, in a case where the detection unit 1250 is provided at a position after the recycled material 1010 is mixed with the virgin material 1020 (for example, the resin introduction unit 1210), the detection unit 1250 detects the content ratio of the impurities with respect to the total of the recycled material 1010 and the virgin material 1020, as the impurities in the recycled material 1010.

The detection unit 1250 is not particularly limited, as long as it is capable of detecting impurities. In addition, the impurities denote substances other than a main component resin in the recycled material. Organic substances such as resins different from the main component resin in the recycled material and inorganic substances such as metal and glass are given as examples. In one embodiment, a near-infrared spectrophotometer (NIR), an infrared spectrophotometer (IR), an ultraviolet-visible spectrophotometer (UV-Vis), a Raman spectrophotometer, a capacitance proximity sensor, and the like can be used for detecting impurities of organic substances such as resins. A magnetic sensor, an inductive proximity sensor, a capacitance proximity sensor, and the like can be used for detecting impurities of metal. An X-ray detector or the like can be used for detecting impurities other than the metal (glass and the like).

The virgin material introduction unit 1220 includes the resin transfer device 1270, and the resin transfer device 1270 is connected with an outlet in a lower part (on a downstream side) of the virgin material introduction unit 1220. In FIG. 1, the virgin material introduction unit 1220 is connected with the mixing unit 1260, but may be connected with the resin introduction unit 1210. The resin transfer device 1270 is capable of adjusting a condition related to an introduction amount of the virgin material 1020 into the thermal decomposition treatment unit 1110, for example, a condition that can change an introduction amount, an introduction speed, and the like. The resin transfer device 1270 is not particularly limited, but a conveyor, a screw feeder, or the like is given as an example. In addition, the introduction amount or the introduction speed of the virgin material 1020 may be automatically adjusted by the thermal decomposition treatment apparatus 1000, or may be adjusted by the operator.

The mixing unit 1260 mixes the recycled material 1010 and the virgin material 1020 before the recycled material and the virgin material are introduced into the resin introduction unit 1210 to make the recycled material 1010 and the virgin material 1020 uniform, so that it is possible to suppress unevenness of impurities in the resin mixture material. The mixing unit 1260 is not particularly limited, but a mixing device including a stirrer, a vibrator, and the like is given as an example. The mixing unit 1260 is connected with the resin introduction unit 1210, and may be connected with the resin introduction unit 1210 through the resin transfer device.

(Decomposition Product Recovery Part)

The decomposition product recovery part 1300 includes a storage unit 1310, and the storage unit 1310 is configured to recover a decomposition product (a monomer or the like) that has been decomposed by the thermal decomposition treatment unit 1110. The decomposition product contains a decomposition gas, residues, and the like, and the storage unit 1310 is configured to separate the decomposition gas and the residues from each other. A discharge port of the decomposition gas is provided at an upper part, and a discharge port of the residue is provided at a lower part. The decomposition gas is transferred from the discharge port to a condenser 1320, where the decomposition gas condenses into a liquid decomposition product. An outlet of the liquid decomposition product is provided at a lower part of the condenser 1320, and the liquid decomposition product is recovered in a recovery tank 1330. A pump 1340 that discharges residual gas is connected with the recovery tank 1330. Residues are taken out from the outlet to a residue storage unit 1350, and are stored.

In one embodiment, the thermal decomposition treatment apparatus1000 includes a physical property detection unit 1360. The physical property detection unit 1360 detects the physical properties of the decomposition product that has been decomposed by the thermal decomposition treatment unit 1110, and may detect a decomposition gas or a liquid decomposition product. In FIG. 1, the physical property detection unit 1360 is provided at the storage unit 1310, but may be provided at the recovery tank 1330. The physical property detection unit 1360 is capable of identifying a decomposition product, and is capable of measuring, for example, a molecular amount of the decomposition product (a monomer). A mass spectrometer (MS), a gas chromatograph (GC), or the like is given as an example of the physical property detection unit 1360 for detecting a decomposition gas. A mass spectrometer (MS), a gas chromatograph (GC), a liquid chromatograph (LC), or the like is given as an example of the physical property detection unit 1360 for detecting a liquid decomposition product.

<Thermal Decomposition Treatment Apparatus According to Another Embodiment>

A thermal decomposition treatment apparatus according to another embodiment includes: a thermal decomposition treatment unit configured to thermally decompose a recycled material containing a resin; a detection unit configured to detect an impurity in a decomposition product that has been decomposed by the thermal decomposition treatment unit; and a determination unit configured to determine a condition related to an introduction amount of a virgin material of the resin to be introduced, together with the recycled material, into the thermal decomposition treatment unit, based on a detection result of the detection unit. This configuration enables a thermal decomposition treatment on the resin under an appropriate thermal decomposition condition. The thermal decomposition treatment apparatus according to another embodiment includes a detection unit configured to detect impurities in a decomposition product, instead of the detection unit 1250, which is configured to detect the impurities in the recycled material 1010, and which is included in the thermal decomposition treatment apparatus 1000 illustrated in FIG. 1. Hereinafter, parts different from the thermal decomposition treatment apparatus 1000 according to one embodiment will be mainly described. Note that the same components are denoted by the same reference numerals.

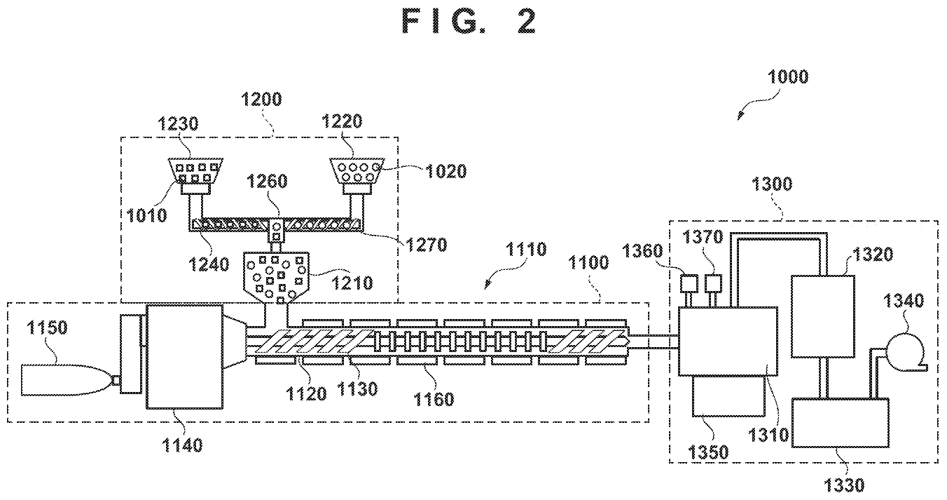

FIG. 2 is a schematic view of a thermal decomposition treatment apparatus according to another embodiment. A thermal decomposition treatment apparatus 1000 includes a thermal treatment part 1100, a resin introduction part 1200, and a decomposition product recovery part 1300. In the thermal decomposition treatment apparatus according to another embodiment, the decomposition product recovery part 1300 includes a detection unit 1370 configured to detect impurities in the decomposition product. In FIG. 2, the detection unit 1370 is provided at the storage unit 1310, but may be provided at the recovery tank 1330, the residue storage unit 1350, or the like. Hereinafter, the detection unit 1370 for detecting impurities in the decomposition product will be referred to as an impurity detection unit, in some cases.

The detection unit 1370 is configured to detect a content ratio of the impurities or an amount of the impurities. The storage unit 1310 includes a physical property detection unit 1360, but the impurity detection unit 1370 may also be configured to detect physical properties of the impurities. Note that the detection unit 1370 detects the content ratio of the impurities with respect to the total of the recycled material 1010 and the virgin material 1020, as the impurities in the recycled material 1010. In addition, as the detection unit 1370, the detection unit 1250 that has been described above, analytical equipment or the like similar to the physical property detection unit 1360, and the like can be used.

<Thermal Decomposition Treatment Apparatus According to Still Another Embodiment>

A thermal decomposition treatment apparatus according to still another embodiment includes an impurity removing unit configured to remove a hardly thermally decomposable impurity, when an impurity detection unit configured to detect the impurity in the recycled material detects the hardly thermally decomposable impurity. This configuration enables a reduction in the load applied onto the thermal decomposition treatment apparatus. In the thermal decomposition treatment apparatus according to still another embodiment, the resin introduction part 1200 in the thermal decomposition treatment apparatus 1000 illustrated in FIGS. 1 and 2 includes the impurity removing unit. Hereinafter, parts different from the thermal decomposition treatment apparatus 1000 according to the above embodiments will be mainly described. Note that the same components are denoted by the same reference numerals.

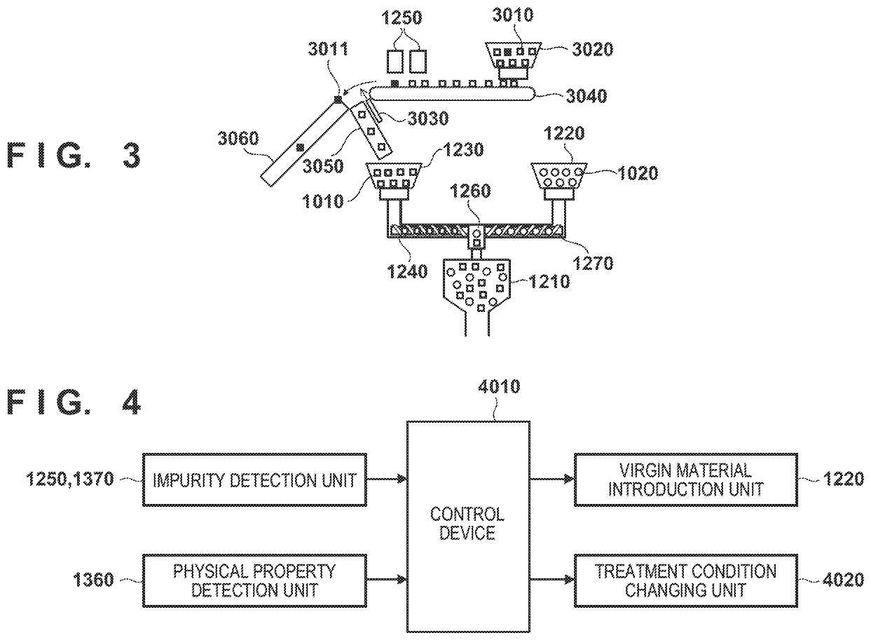

FIG. 3 is a schematic diagram of a resin introduction part of a thermal decomposition treatment apparatus according to still another embodiment. The resin introduction part 1200 includes an introduction unit 3020 for a recycled material 3010, which is a material before hardly thermally decomposable impurities 3011 are removed, an impurity detection unit 1250, and an impurity removing unit 3030. Hereinafter, the recycled material before the hardly thermally decomposable impurities are removed will be referred to as a raw material, and the introduction unit for introducing the recycled material before the hardly thermally decomposable impurities are removed will be referred to as a raw material introduction unit, in some cases.

The raw material introduction unit 3020 includes a raw material transfer device 3040. The raw material transfer device 3040 is not particularly limited, as long as it is capable of transferring the raw material 3010. However, a conveyor, a screw feeder, or the like is given as an example. A detection unit 1250 for detecting impurities in the recycled material 1010 is provided in a transfer passage on which the raw material 3010 is transferred in the raw material transfer device 3040.

The detection unit 1250 is configured to detect the hardly thermally decomposable impurities 3011 and a content ratio of the impurities or an amount of the impurities in the raw material 3010. As the detection unit 1250, a unit capable of detecting the hardly thermally decomposable impurities 3011 and the content ratio of the impurities or the amount of the impurities in the raw material 3010 may be adopted. Alternatively, a unit capable of detecting the hardly thermally decomposable impurities 3011 and a unit capable of detecting the content ratio of the impurities or the amount of the impurities in the raw material 3010 may be separately adopted.

As the detection unit 1250 for detecting the content ratio of the impurities or the amount of the impurities in the raw material 3010, analytical equipment or the like similar to the detection unit 1250 that has been described above can be used. Further, the hardly thermally decomposable impurities 3011 are substances that hardly decompose under a thermal decomposition condition of the resin mixture material in the thermal decomposition treatment unit 1110, and inorganic substances such as metal and glass are given as examples. As the detection unit 1250 for detecting the hardly thermally decomposable impurities 3011, a magnetic sensor, an inductive proximity sensor, a capacitive proximity sensor, an X-ray detector, and the like can be used.

The impurity removing unit 3030 is provided near an end of the raw material transfer device 3040 in the transfer direction. In a case where the hardly thermally decomposable impurities 3011 are detected by the detection unit 1250, the impurity removing unit 3030 is capable of removing the hardly thermally decomposable impurities 3011, before the hardly thermally decomposable impurities 3011 are introduced into the recycled material introduction unit 1230. The impurity removing unit 3030 is not particularly limited. An air gun, a magnet, or the like is given as an example.

In FIG. 3, an air gun is used as the impurity removing unit 3030. The hardly thermally decomposable impurities 3011 are blown off by the air gun, are deviated from an introduction passage 3050 extending toward the recycled material introduction unit 1230, are directed to a discharge passage 3060, and are removed from the thermal decomposition treatment apparatus 1000. In addition, in this manner, the hardly thermally decomposable impurities may be automatically removed by the thermal decomposition treatment apparatus 1000, or may be removed by the operator.

Further, in a thermal decomposition treatment apparatus according to still another embodiment, after the hardly thermally decomposable impurities 3011 are removed by the impurity removing unit 3030, the thermal decomposition treatment for the resin mixture material is carried out. However, after the hardly thermally decomposable impurities 3011 are removed by the impurity removing unit 3030 depending on the amount or type of the hardly thermally decomposable impurities 3011, the thermal decomposition treatment apparatus 1000 may be configured to be stopped and ended.

In still another embodiment, the thermal decomposition treatment apparatus may include the detection unit 1250 configured to detect impurities in the recycled material, and the detection unit 1370 configured to detect the impurities in the decomposition product.

<Control Device>

FIG. 4 is a block diagram of the thermal decomposition treatment apparatus. The thermal decomposition treatment apparatus 1000 includes a control device 4010. The control device 4010 includes a processing unit, a memory unit such as a RAM and a ROM, and an interface unit that relays transmission and reception of signals between an external device and the control device 4010. The processing unit is a processor represented by a CPU, and executes a program stored in the memory unit to control the configuration of the thermal decomposition treatment apparatus 1000. Various types of data, in addition to the program executed by the processing unit, are stored in the memory unit. Detection results of various detection units are supplied to the interface unit, and the processing unit controls the virgin material introduction unit and the like, based on the detection results that have been supplied.

The control device 4010 is connected with the impurity detection unit 1250 or 1370, the physical property detection unit 1360, and the like. The control device 4010 includes a determination unit that determines a condition related to an introduction amount of the virgin material 1020 of a resin to be introduced, together with the recycled material 1010, into the thermal decomposition treatment unit 1110, based on a detection result of the impurity detection unit 1250 or 1370. The virgin material introduction unit 1220 introduces the virgin material based on the condition related to the introduction amount of the virgin material 1020 that has been determined by the determination unit.

Next, an example will be given with regard to the determination of the condition related to the introduction amount of the virgin material 1020, but such an example is a non-limiting example. For example, the control device 4010 calculates an average content ratio of impurities in a resin mixture material or a decomposition product per unit time, based on the content ratio of impurities that has been detected by the impurity detection unit 1250 or 1370. Note that the content ratio of the impurities that has been detected by the impurity detection unit 1250 or 1370 may be set to an average content ratio of impurities in the resin mixture material or the decomposition product per unit time. The determination unit determines an introduction amount of the virgin material 1020 per unit time, based on the average content ratio and the introduction amounts of the recycled material 1010 and the virgin material 1020 per unit time, so that the content ratio of the impurities in the resin mixture material or the decomposition product is a predetermined value. Subsequently, transfer conditions or the like of the resin transfer device 1240 (for example, a screw feeder) of the virgin material introduction unit 1220 are determined so that the introduction amount is achieved. The virgin material introduction unit 1220 introduces the virgin material into the thermal decomposition treatment unit 1110, based on the conditions that have been determined. In addition, in a case where the virgin material 1020 contains impurities, the introduction amount of the virgin material 1020 per unit time is determined in consideration of the impurities. Note that the content ratio of the impurities in the virgin material 1020 is low and known.

Further, the control device 4010 includes a treatment condition determination unit that determines conditions in a thermal decomposition treatment of the resin mixture material, based on the detection result of the physical property detection unit 1360. A treatment condition changing unit 4020 is adjusted, based on the conditions in the thermal decomposition treatment that have been determined by the treatment condition determination unit. As the treatment condition changing unit 4020, the resin introduction unit 1210, the recycled material introduction unit 1230, and the virgin material introduction unit 1220, which are capable of adjusting a period of time (a staying period of time) in the thermal decomposition treatment through the adjustment of the introduction amount and the introduction speed of the resin, the heater 1160 capable of adjusting the temperature in the thermal decomposition treatment, the speed reducer 1140 capable of adjusting the stirring amount of the resin that is being melted and decomposed, or the like can be given. The conditions in the thermal decomposition treatment of the resin mixture material are changed based on the detection result of the physical property detection unit 1360 so that a desired decomposition product is generated. Accordingly, a decomposition product (a monomer) with high purity is obtainable.

<Thermal Decomposition Treatment Method According to One Embodiment>

A thermal decomposition treatment method according to one embodiment includes thermally decomposing a recycled material containing a resin; detecting an impurity in the recycled material to be introduced in the thermally decomposing; and determining a condition related to an introduction amount of a virgin material of the resin to be thermally decomposed, together with the recycled material, in the thermally decomposing, based on a detection result of the determining. This configuration enables a thermal decomposition treatment on the resin under an appropriate thermal decomposition condition.

(Resin)

As a resin of the recycled material and the virgin material, an acrylic-based resin, an olefin-based resin (polyethylene, polypropylene, or the like), polyvinyl chloride, a polyester-based resin (polyethylene terephthalate, polycarbonate, or the like), and a polystyrene-based resin can be given.

(Detection Step)

The impurities in the recycled material 1010 are detected by the detection unit 1250 provided between the recycled material introduction unit 1230 and the resin introduction unit 1210. The impurities may be detected continuously or intermittently.

(Determination Step)

As described above, the control device 4010 determines a condition related to the introduction amount of the virgin material 1020 of a resin to be introduced, together with the recycled material 1010, into the thermal decomposition treatment unit 1110, based on the detection result of the impurity detection unit 1250.

(Introduction Step)

The recycled material 1010 and the virgin material 1020 of the resin are introduced into the thermal decomposition treatment unit 1110 through the resin introduction unit 1210. In addition, the resin mixture material may be automatically introduced by the thermal decomposition treatment apparatus1000 or may be introduced by the operator.

The virgin material 1020 is introduced into the thermal decomposition treatment unit 1110 through the resin introduction unit 1210, based on the determined condition related to the introduction amount of the virgin material 1020. For example, the virgin material 1020 is introduced into the resin introduction unit 1210 by the resin transfer device 1240 (for example, a screw feeder) so that the determined introduction amount of the virgin material 1020 per unit time is achieved, and the virgin material 1020, together with the recycled material 1010, is introduced into the thermal decomposition treatment unit 1110.

(Thermal Decomposition Step)

The resin mixture material that has been introduced into the thermal decomposition treatment unit 1110 is melted in a molten resin zone, and is heated at, for example, 350° C. to 450° C. in the thermal decomposition zone on a downstream side, and is thermally decomposed. Then, a decomposition product is generated. The introduction amount of the resin mixture material per unit time varies depending on the size and capability of the thermal decomposition treatment unit 1110 and the thermal decomposition treatment conditions (a treatment time, a temperature, and the like). However, the resin mixture material can be introduced at approximately 0.7 kg/hr to 150 kg/hr. In addition, the introduction amount of the resin mixture material per unit time is adjustable by the resin introduction unit 1210, the recycled material introduction unit 1230, and the virgin material introduction unit 1220. In addition, the stirring amount of the resin while the resin is being melted and decomposed is adjustable by the rotation speed of the screw 1130. The rotation speed of 30 rpm to 740 rpm is given as an example.

(Recovery Step)

The decomposition product that has been generated by the thermal decomposition treatment unit 1110 is stored in the storage unit 1310. In the storage unit 1310, the decomposition product is separated into a decomposition gas and residues. The decomposition gas is transferred to the condenser 1320, is condensed into a liquid decomposition product, and is recovered in the recovery tank 1330. The residues are stored in the residue storage unit 1350.

<Thermal Decomposition Treatment Method According to Another Embodiment>

A thermal decomposition treatment method according to another embodiment includes thermally decomposing a recycled material containing a resin; detecting an impurity in a decomposition product that has been decomposed by the thermally decomposing; and determining a condition related to an introduction amount of a virgin material of the resin to be thermally decomposed, together with the recycled material, in the thermally decomposing, based on a detection result of the detecting. This configuration enables a thermal decomposition treatment on the resin under an appropriate thermal decomposition condition. Hereinafter, parts different from the thermal decomposition treatment method according to one embodiment will be mainly described.

(Detection Step)

The thermal decomposition treatment method according to another embodiment includes a detection step of detecting impurities in a decomposition product, instead of the detection step of detecting impurities in the recycled material 1010. The decomposition product that has been generated by the thermal decomposition treatment unit 1110 is detected by the impurity detection unit 1370.

<Flowchart of Introduction of Virgin Material According to One Embodiment>

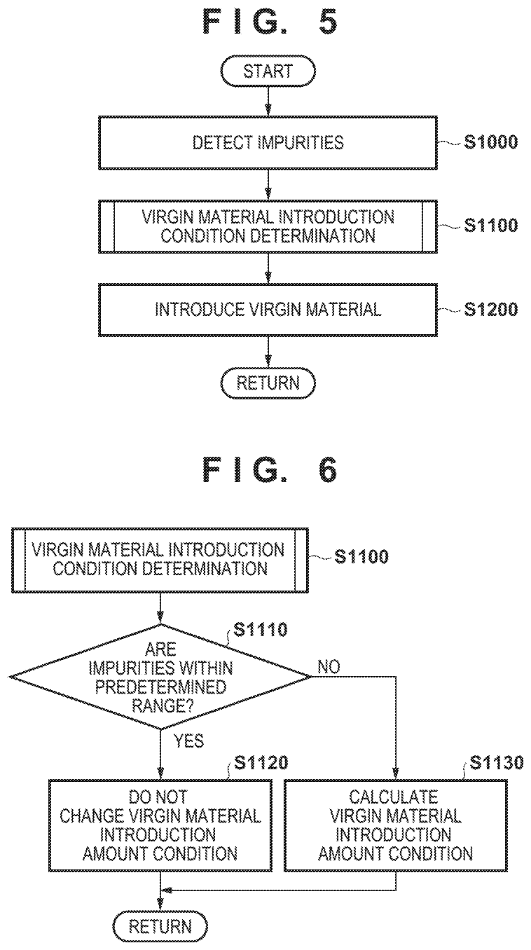

FIG. 5 is a flowchart illustrating introduction of the virgin material according to one embodiment. In step S1000 (hereinafter, simply referred to as “S1000”, and the same applies to the other steps), the detection unit 1250 or 1370 detects the impurities in the recycled material 1010 or the decomposition product. For example, the impurity detection unit 1250 or 1370 detects the content ratio of the impurities in the recycled material 1010 or the decomposition product.

Next, the process proceeds to S1100. The condition related to the introduction amount of the virgin material 1020 to be introduced, together with the recycled material 1010, into the thermal decomposition treatment unit 1110 is determined, based on the detection result of the detection unit 1250 or 1370. This determination process will be described with reference to FIG. 6.

Next, the process proceeds to S1200, and the virgin material 1020 is introduced into the thermal decomposition treatment unit 1110, based on the introduction amount that has been determined. For example, the virgin material 1020 is introduced into the resin introduction unit 1210 by the resin transfer device 1240 (for example, a screw feeder) so that the determined introduction amount of the virgin material 1020 per unit time is achieved.

FIG. 6 is a flowchart for determining the condition related to the introduction amount of the virgin material. In S1100, the condition related to the introduction amount of the virgin material 1020 to be introduced into the thermal decomposition treatment unit 1110 is determined. The process proceeds to S1110, and determines whether the impurities in the resin mixture material or the decomposition product fall within a predetermined range. In a case where the impurities in the resin mixture material or the decomposition product fall within the predetermined range, the process proceeds to S1120. In the other case, the process proceeds to S1130.

In the determination in S1110, the determination is made, based on the average content ratio of the impurities in the resin mixture material or the decomposition product per unit time that has been calculated, based on the detection result of the detection unit 1250 or 1370. The range of the impurities in the resin mixture material or the decomposition product in S1110 is set to include, for example, the content ratio of the impurities in the resin mixture material that is determined beforehand in accordance with the thermal decomposition treatment conditions or the like. In addition, the range (broadness) of the impurities can be set to a range, of the content ratio of the impurities in the resin mixture material or the decomposition product, in which a desired decomposition product is generated even when the resin mixture material is thermally decomposed without the thermal decomposition treatment conditions that have been set beforehand being significantly changed.

The range of the content ratio of the impurities in the resin mixture material or the decomposition product is set such that, in one embodiment, the content ratio of the impurities in the resin mixture material or the decomposition product is equal to or less than 10 wt %. In another embodiment, the content ratio of the impurities in the resin mixture material or the decomposition product is equal to or less than 5 wt %. In still another embodiment, the content ratio of the impurities in the resin mixture material or the decomposition product is equal to or less than 1 wt %. Accordingly, the thermal decomposition treatment is appropriately carried out, and a desired decomposition product is obtainable.

In addition, the range of the content ratio of the impurities in the resin mixture material or the decomposition product is set such that, in one embodiment, the content ratio of the impurities in the resin mixture material or the decomposition product is equal to or more than 0.05 wt %. In another embodiment, the content ratio of the impurities in the resin mixture material or the decomposition product is equal to or more than 0.1 wt %. In still another embodiment, the content ratio of the impurities in the resin mixture material or the decomposition product is equal to or more than 0.5 wt %. Accordingly, the thermal decomposition treatment of the recycled material is efficiently carried out.

In a case where the impurities in the resin mixture material or the decomposition product fall within the predetermined range in S1110, the process proceeds to S1120. Then, a determination is made not to change the condition related to the introduction amount of the virgin material 1020, and the process returns to S1100.

In a case where the impurities in the resin mixture material or the decomposition product do not fall within the predetermined range in S1110, the process proceeds to S1130. Then, the control device 4010 calculates and determines the condition related to the introduction amount of the virgin material 1020 as described above. Its result is set as the condition related to the introduction amount of the virgin material.

<Flowchart of Introduction of Virgin Material According to Another Embodiment>

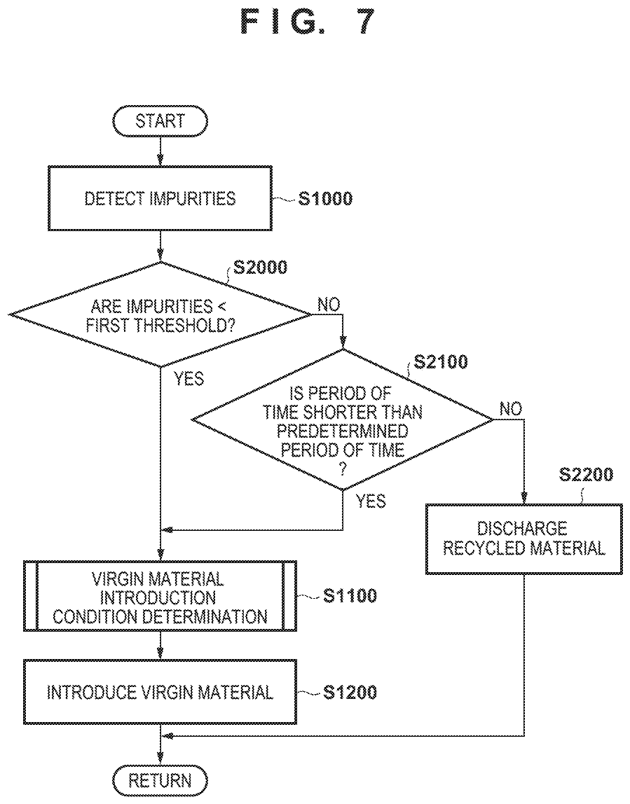

FIG. 7 is a flowchart illustrating the introduction of the virgin material according to another embodiment. In the introduction of the virgin material according to another embodiment, whether to introduce the virgin material is determined in accordance with the content ratio of the impurities that has been detected. Hereinafter, parts different from the introduction of the virgin material according to one embodiment will be mainly described. In addition, the same steps are denoted by the same reference numerals.

In S1000, the detection unit 1250 or 1370 detects the content ratio of impurities in the recycled material 1010 or the decomposition product. The process proceeds to S2000 to determine whether the content ratio of the impurities in the resin mixture material or the decomposition product is smaller than a first threshold. In a case where the content ratio of the impurities is smaller than the first threshold, the process proceeds to S1100. In the other case, the process proceeds to S2100. The descriptions have been given with regard to S1100 and S1200 with reference to FIGS. 5 and 6, and therefore the descriptions will be omitted.

In the determination in S2000, the determination is made, based on the average content ratio of the impurities in the resin mixture material or the decomposition product per unit time that has been calculated, based on the detection result of the detection unit 1250 or 1370. The first threshold of the content ratio of the impurities in the resin mixture material or the decomposition product in S2000 corresponds to a content ratio at which a desired decomposition product is hardly obtained appropriately in the thermal decomposition treatment, and 15 wt % is given as an example.

The process proceeds to S2100 to determine whether the period of time, while the content ratio of the impurities in the resin mixture material or the decomposition product is continuously detected at equal to or larger than the first threshold, is shorter than a predetermined period of time. In a case where the period of time, while the content ratio of the impurities is continuously detected at equal to or larger than the first threshold, is shorter than the predetermined period of time, the process proceeds to S1100. In the other case, the process proceeds to S2200. The descriptions have been given with regard to S1100 and S1200 with reference to FIGS. 5 and 6, and therefore the descriptions will be omitted.

In addition, the control device 4010 includes a counter (a measurement unit) that measures an elapsed time after receiving a detection signal from the detection unit 1250 or 1370. The control device 4010 is capable of making the above determination based on a measurement result. In addition, the time may be automatically measured by the thermal decomposition treatment apparatus 1000, or may be measured by the operator. In addition, the predetermined period of time is not particularly limited, but a period shorter than 60 seconds is given as an example.

The process proceeds to S2200, and in a case where the period of time, while the content ratio of the impurities in the resin mixture material or the decomposition product is continuously detected at equal to or larger than the first threshold, is equal to or longer than the predetermined period of time, the recycled material 1010 is discharged from the discharge passage 3060 for a certain period of time, and the process returns to S1000. In addition, a method for discharging the recycled material 1010 is not particularly limited. However, the recycled material may be discharged with use of the thermal decomposition treatment apparatus 1000 illustrated in FIG. 3, or may be discharged by the provision of a switching unit that switches the transfer direction toward either the introduction passage 3050 or the discharge passage 3060 at an end in the transfer direction of the raw material transfer device 3040. Further, the recycled material 1010 may be automatically discharged by the thermal decomposition treatment apparatus 1000, or may be discharged by the operator.

In the introduction of the virgin material according to another embodiment, the recycled material 1010 locally containing a large amount of impurities is removed from the thermal decomposition treatment step. Accordingly, the used amount of the virgin material 1020 can be reduced, and the thermal decomposition treatment of the resin can be carried out without the thermal decomposition treatment conditions being significantly changed. In addition, the discharge period of time is not particularly limited, but a period equal to or longer than 20 seconds and equal to or shorter than 120 seconds is given as an example.

<Flowchart of Introduction of Virgin Material According to Still Another Embodiment>

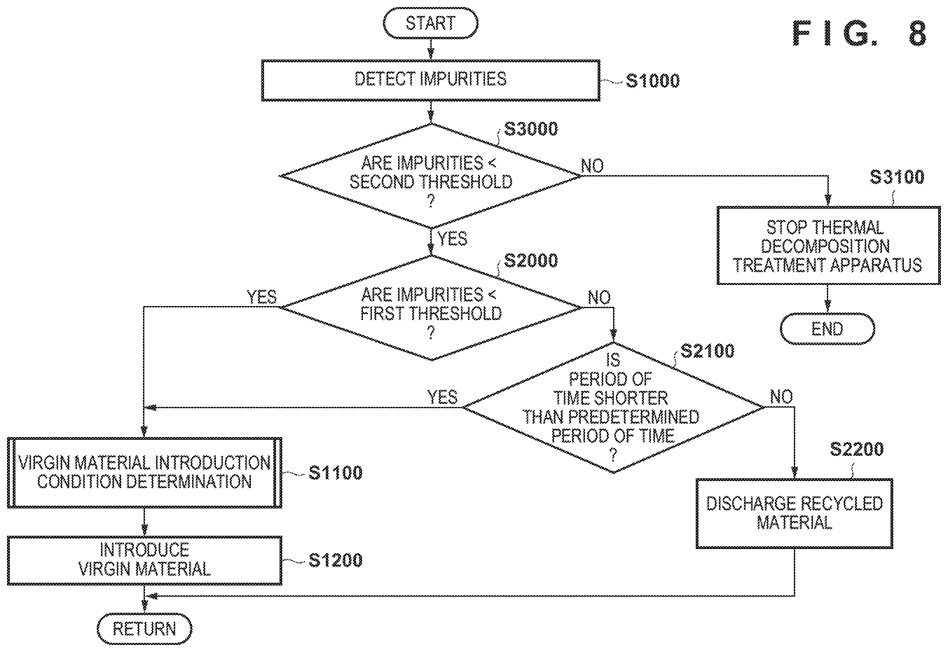

FIG. 8 is a flowchart for describing the introduction of the virgin material according to still another embodiment. In the introduction of the virgin material according to still another embodiment, the stop of the thermal decomposition treatment apparatus is determined in accordance with the content ratio of the impurities that has been detected. Hereinafter, parts different from the introduction of the virgin material according to another embodiment will be mainly described. In addition, the same steps are denoted by the same reference numerals.

In S1000, the detection unit 1250 or 1370 detects the content ratio of impurities in the recycled material 1010 or the decomposition product. The process proceeds to S3000 to determine whether the content ratio of the impurities in the resin mixture material or the decomposition product is smaller than a second threshold. In a case where the content ratio of the impurities is smaller than the second threshold, the process proceeds to S2000. In the other case, the process proceeds to S3100. The descriptions have been given with regard to S2000 to S1200 with reference to FIGS. 5 to 7, and therefore the descriptions will be omitted.

In the determination in S3000, the determination is made, based on the average content of the impurities in the resin mixture material or the decomposition product per unit time that has been calculated, based on the detection result of the detection unit 1250 or 1370. The second threshold of the content ratio of the impurities in the resin mixture material or the decomposition product in S3000 corresponds to a content ratio at which it can be difficult to carry out the thermal decomposition treatment, and 20 wt % is given as an example.

In a case where the content ratio of the impurities in the resin mixture material or the decomposition product is detected to be larger than the second threshold, the process proceeds to S3100. Then, the thermal decomposition treatment apparatus 1000 is stopped and ended. Accordingly, a large amount consumption of the virgin material 1020 is prevented.

<Summary of Embodiments>

The above embodiments disclose at least the following thermal decomposition treatment apparatus.

1. A thermal decomposition treatment apparatus according to the above embodiment includes:

a thermal decomposition treatment unit (1110) configured to thermally decompose a recycled material (1010) containing a resin;

a detection unit (1250) configured to detect an impurity in the recycled material (1010) to be introduced into the thermal decomposition treatment unit (1110); and

a determination unit configured to determine a condition related to an introduction amount of a virgin material (1020) of the resin to be introduced, together with the recycled material (1010), into the thermal decomposition treatment unit (1110), based on a detection result of the detection unit (1250).

According to this embodiment, temporal variations of impurities in the resin to be thermally decomposed are reduced, and the resin can be thermally decomposed under an appropriate thermal decomposition condition without the thermal decomposition treatment condition being significantly changed, so a desired monomer with high purity is obtainable. In addition, the introduction amount of the virgin material can be quickly changed with respect to a change in the impurities in the recycled material.

2. The above embodiment further includes

a resin introduction unit (1210) configured to introduce the resin into the thermal decomposition treatment unit (1110), in which

the detection unit (1250) detects the impurity on an upstream side of the resin introduction unit (1210).

According to this embodiment, impurities in the recycled material can be appropriately detected.

3. The above embodiment further includes

a resin introduction unit (1210) configured to introduce the resin into the thermal decomposition treatment unit (1110), in which

the detection unit (1250) detects the impurity in the resin introduction unit (1210).

According to this embodiment, the impurities in the recycled material in the resin mixture material can be appropriately detected.

4. The above embodiment further includes

an impurity removing unit (3030) configured to remove a hardly thermally decomposable impurity (3011), when the detection unit (1250) detects the hardly thermally decomposable impurity (3011).

According to this embodiment, it is possible to reduce the load that is caused by the impurities that is hardly removed at thermal decomposition treatment temperatures of the resin and that is applied onto the thermal decomposition treatment apparatus.

5. A thermal decomposition treatment apparatus according to the above embodiment includes:

a thermal decomposition treatment unit (1110) configured to thermally decompose a recycled material (1010) containing a resin;

a detection unit (1370) configured to detect an impurity in a decomposition product that has been decomposed by the thermal decomposition treatment unit (1110); and

a determination unit configured to determine a condition related to an introduction amount of a virgin material (1020) of the resin to be introduced, together with the recycled material (1010), into the thermal decomposition treatment unit (1110), based on a detection result of the detection unit (1370).

According to this embodiment, temporal variations of impurities in the resin to be thermally decomposed are reduced, and the resin can be thermally decomposed under an appropriate thermal decomposition condition without the thermal decomposition treatment condition being significantly changed, so a desired monomer with high purity is obtainable. In addition, the impurities in the decomposition product and the impurities in the resin to be thermally decomposed are substantially the same with each other. Accordingly, it is possible to determine a more appropriate condition related to the introduction amount of the virgin material.

6. The above embodiment further includes

a storage unit (1310) configured to store the decomposition product, in which

the detection unit (1370) detects the impurity in the storage unit (1310).

According to this embodiment, impurities in the recycled material can be appropriately detected.

7. The above embodiment further includes

a storage unit (1310) configured to store the decomposition product, in which

the detection unit (1370) detects the impurity on a downstream side of the storage unit (1310).

According to this embodiment, impurities in the recycled material can be appropriately detected.

8. The above embodiment further includes

a detection unit (1250) configured to detect the impurity in the recycled material (1010) to be introduced into the thermal decomposition treatment unit (1110); and

an impurity removing unit (3030) configured to remove a hardly thermally decomposable impurity (3011), when the detection unit (1250) detects the hardly thermally decomposable impurity (3011).

According to this embodiment, it is possible to reduce the load that is caused by the impurities that is hardly removed at thermal decomposition treatment temperatures of the resin and that is applied onto the thermal decomposition treatment apparatus.

9. In the above embodiment,

the detection unit (1250, 1370) is configured to detect a content ratio of the impurity, and

the determination unit determines the condition related to the introduction amount of the virgin material (1020) such that the introduction amount of the virgin material (1020) is larger, as the content ratio of the impurity is higher than a case where the content ratio of the impurity is low.

According to this embodiment, the resin can be thermally decomposed under an appropriate thermal decomposition condition, so a desired monomer with high purity is obtainable.

10. The above embodiment further includes

a physical property detection unit (1360) configured to detect a physical property of the decomposition product that has been decomposed by the thermal decomposition treatment unit (1110); and

a treatment condition determination unit configured to determine a condition in the thermal decomposition treatment, in which

the treatment condition determination unit determines the condition in the thermal decomposition treatment, based on a detection result of the physical property detection unit (1360).

According to this embodiment, the introduction amount of the resin or the condition for the thermal decomposition treatment can be controlled, based on the information of the decomposition product, so a desired monomer with high purity is obtainable.

11. The above embodiment further includes

a resin introduction unit (1210) configured to introduce the resin into the thermal decomposition treatment unit (1110); and

a virgin material introduction unit (1220) configured to introduce the virgin material (1020) on an upstream side of the resin introduction unit (1210), based on a determination of the determination unit.

According to this embodiment, the virgin material can be appropriately introduced.

12. The above embodiment further includes

a resin introduction unit (1210) configured to introduce the resin into the thermal decomposition treatment unit (1110); and

a virgin material introduction unit (1220) configured to introduce the virgin material (1020) in the resin introduction unit (1210), based on a determination of the determination unit.

According to this embodiment, the virgin material can be appropriately introduced.

13. The above embodiment further includes

a resin introduction unit (1210) configured to introduce the resin into the thermal decomposition treatment unit (1110); and

a mixing unit (1260) configured to mix the recycled material (1010) and the virgin material (1020) on an upstream side of the resin introduction unit (1210).

According to this embodiment, it is possible to reduce unevenness in the distribution of the virgin material in the resin mixture material.

14. The above embodiment further includes

a discharge unit configured to discharge the recycled material (1010), in which

the detection unit (1250, 1370) is configured to detect a content ratio of the impurity, and when the detection unit (1250, 1370) detects the content ratio at equal to or larger than a first threshold for a predetermined period of time, the discharge unit discharges the recycled material.

According to this embodiment, the used amount of the virgin material can be reduced, in a case where impurities are locally contained in the recycled material.

15. The above embodiment further includes

a stop unit configured to stop the thermal decomposition treatment apparatus (1000), in which

the detection unit (1250, 1370) is configured to detect the content ratio of the impurity, and when the detection unit (1250, 1370) detects the content ratio at equal to or larger than a second threshold, the stop unit stops the thermal decomposition treatment apparatus (1000).

According to this embodiment, a large amount consumption of the virgin material is prevented.

16. In the above embodiment,

the thermal decomposition treatment unit (1110) includes a screw (1130) configured to mix the resin.

According to this embodiment, the thermal decomposition treatment can be carried out under an optimum condition.

17. A thermal decomposition treatment method in the above embodiment includes:

thermally decomposing a recycled material (1010) containing a resin;

detecting an impurity in the recycled material (1010) to be introduced in the thermally decomposing; and

determining a condition related to an introduction amount of a virgin material (1020) of the resin to be thermally decomposed, together with the recycled material (1010), in the thermally decomposing, based on a detection result of the detecting.

According to this embodiment, temporal variations of impurities in the resin to be thermally decomposed are reduced, and the resin can be thermally decomposed under an appropriate thermal decomposition condition without the thermal decomposition treatment condition being significantly changed, so a desired monomer with high purity is obtainable. In addition, the introduction amount of the virgin material can be quickly changed with respect to a change in the impurities in the recycled material.

18. A thermal decomposition treatment method in the above embodiment includes:

thermally decomposing a recycled material (1010) containing a resin;

detecting an impurity in a decomposition product that has been decomposed by the thermally decomposing; and

determining a condition related to an introduction amount of a virgin material (1020) of the resin to be thermally decomposed, together with the recycled material (1010), in the thermally decomposing, based on a detection result of the detecting.

According to this embodiment, temporal variations of impurities in the resin to be thermally decomposed are reduced, and the resin can be thermally decomposed under an appropriate thermal decomposition condition without the thermal decomposition treatment condition being significantly changed, so a desired monomer with high purity is obtainable. In addition, the impurities in the decomposition product and the impurities in the resin to be thermally decomposed are substantially the same with each other. Accordingly, it is possible to determine a more appropriate condition related to the introduction amount of the virgin material.

The invention is not limited to the foregoing embodiments, and various variations/changes are possible within the spirit of the invention.

For example, in the introduction of the virgin material according to still another embodiment, both the first threshold and the second threshold are essential, and the second threshold is larger than the first threshold. However, a thermal decomposition treatment method using either one of the thresholds may be applicable.

What is claimed is:

1. A thermal decomposition treatment apparatus comprising:
a thermal decomposition treatment unit configured to thermally decompose a recycled material containing a resin;
a detection unit configured to detect an impurity in the recycled material to be introduced into the thermal decomposition treatment unit; and
a determination unit configured to determine a condition related to an introduction amount of a virgin material of the resin to be introduced, together with the recycled material, into the thermal decomposition treatment unit, based on a detection result of the detection unit.

2. The thermal decomposition treatment apparatus according to claim 1, further comprising
a resin introduction unit configured to introduce the resin into the thermal decomposition treatment unit, wherein
the detection unit detects the impurity on an upstream side of the resin introduction unit.

3. The thermal decomposition treatment apparatus according to claim 1, further comprising
a resin introduction unit configured to introduce the resin into the thermal decomposition treatment unit, wherein
the detection unit detects the impurity in the resin introduction unit.

4. The thermal decomposition treatment apparatus according to claim 1, further comprising an impurity removing unit configured to remove a hardly thermally decomposable impurity, when the detection unit detects the hardly thermally decomposable impurity.

5. A thermal decomposition treatment apparatus comprising:
a thermal decomposition treatment unit configured to thermally decompose a recycled material containing a resin;
a detection unit configured to detect an impurity in a decomposition product that has been decomposed by the thermal decomposition treatment unit; and
a determination unit configured to determine a condition related to an introduction amount of a virgin material of the resin to be introduced, together with the recycled material, into the thermal decomposition treatment unit, based on a detection result of the detection unit.

6. The thermal decomposition treatment apparatus according to claim 5, further comprising
a storage unit configured to store the decomposition product, wherein
the detection unit detects the impurity in the storage unit.

7. The thermal decomposition treatment apparatus according to claim 5, further comprising
a storage unit configured to store the decomposition product, wherein
the detection unit detects the impurity on a downstream side of the storage unit.

8. The thermal decomposition treatment apparatus according to claim 5, further comprising:
a detection unit configured to detect the impurity in the recycled material to be introduced into the thermal decomposition treatment unit; and
an impurity removing unit configured to remove a hardly thermally decomposable impurity, when the detection unit detects the hardly thermally decomposable impurity.

9. The thermal decomposition treatment apparatus according to claim 1, wherein
the detection unit is configured to detect a content ratio of the impurity, and
the determination unit determines the condition related to the introduction amount of the virgin material such that the introduction amount of the virgin material is larger, as the content ratio of the impurity is higher than a case where the content ratio of the impurity is low.

10. The thermal decomposition treatment apparatus according to claim 1, further comprising:
a physical property detection unit configured to detect a physical property of the decomposition product that has been decomposed by the thermal decomposition treatment unit; and
a treatment condition determination unit configured to determine a condition in the thermal decomposition treatment, wherein
the treatment condition determination unit determines the condition in the thermal decomposition treatment, based on a detection result of the physical property detection unit.

11. The thermal decomposition treatment apparatus according to claim 1, further comprising:
a resin introduction unit configured to introduce the resin into the thermal decomposition treatment unit; and
a virgin material introduction unit configured to introduce the virgin material on an upstream side of the resin introduction unit, based on a determination of the determination unit.

12. The thermal decomposition treatment apparatus according to claim 1, further comprising:
a resin introduction unit configured to introduce the resin into the thermal decomposition treatment unit; and
a virgin material introduction unit configured to introduce the virgin material in the resin introduction unit, based on a determination of the determination unit.

13. The thermal decomposition treatment apparatus according to claim 1, further comprising:
a resin introduction unit configured to introduce the resin into the thermal decomposition treatment unit; and
a mixing unit configured to mix the recycled material and the virgin material on an upstream side of the resin introduction unit.

14. The thermal decomposition treatment apparatus according to claim 1, further comprising
a discharge unit configured to discharge the recycled material, wherein
the detection unit is configured to detect a content ratio of the impurity, and when the detection unit detects the content ratio at equal to or larger than a first threshold for a predetermined period of time, the discharge unit discharges the recycled material.

15. The thermal decomposition treatment apparatus according to claim 1, further comprising
a stop unit configured to stop the thermal decomposition treatment apparatus, wherein
the detection unit is configured to detect the content ratio of the impurity, and when the detection unit detects the content ratio at equal to or larger than a second threshold, the stop unit stops the thermal decomposition treatment apparatus.

16. The thermal decomposition treatment apparatus according to claim 1, wherein the thermal decomposition treatment unit includes a screw configured to mix the resin.

17. A thermal decomposition treatment method comprising:
thermally decomposing a recycled material containing a resin;
detecting an impurity in the recycled material to be introduced in the thermally decomposing; and
determining a condition related to an introduction amount of a virgin material of the resin to be thermally decomposed, together with the recycled material, in the thermally decomposing, based on a detection result of the detecting.

18. A thermal decomposition treatment method comprising:
thermally decomposing a recycled material containing a resin;
detecting an impurity in a decomposition product that has been decomposed by the thermally decomposing; and
determining a condition related to an introduction amount of a virgin material of the resin to be thermally decomposed, together with the recycled material, in the thermally decomposing, based on a detection result of the detecting.
